(19) United States
(12) Patent Application Publication
(10) Pub. No.: US 2012/0136877 A1
(43) Pub. Date: May 31, 2012

(54) System and method for selecting compatible users for activities based on experiences, interests or preferences as identified from one or more web services

(76) Inventors: Shayan G. Zadeh, San Francisco, CA (US); Alexander F. Mehr, San Francisco, CA (US)

(21) Appl. No.: 13/200,229

(22) Filed: Sep. 21, 2011

Related U.S. Application Data
(60) Provisional application No. 61/403,735, filed on Sep. 21, 2010.

(51) Int. Cl. G06F 17/30; G06F 15/16

(52) U.S. Cl. 707/749; 707/E17.005; 707/E17.044

(57) ABSTRACT

A system and method retrieves object experience, interest and preference information from one or more independent web sites or receives it from other independent web services and uses such information to match users of a matching web site for activities.

### RELATED APPLICATION

This application claims the benefit of attorney docket number 1694, U.S. provisional patent application Ser. No. 61/403,735, entitled “Method and Apparatus for Selecting Compatible Users for Activities Based on Experiences, Interests or Preferences as Identified From One or More Web Services” filed by Shayan G. Zadeh and Alex F. Mehr on Sep. 21, 2010, having the same assignee as the present application, and is hereby incorporated by reference in its entirety.

### FIELD OF THE INVENTION

The present invention is related to computer software and more specifically to computer software assisted matching.

### BACKGROUND OF THE INVENTION

Users may wish to be matched with other users to participate in activities with such other users. Users may find the match to be a better fit if the users matched have shared experiences, interests and/or preferences.

However, users find it cumbersome to identify all of their experiences, interests and preferences. They may not even remember their experiences, or realize their preferences in the abstract, though they may be able to determine if they like something when they see it. This makes it difficult for users to accurately identify their experiences, interests and preferences for the purpose of matching, even if the users were willing to identify them.

What is needed is a system and method that can match users for activities based on experiences, interests and preferences without requiring the user to identify all of their experiences, interests and preferences directly to the system and method.

### SUMMARY OF INVENTION

A system and method receives information necessary to retrieve experience, preference or interest information from one or more independent web sites or other web services, and uses the information received to retrieve experience, interest and preference information from such one or more independent web sites or other web services. The system and method may also receive experience, interest and preference information directly from the users.

The experience, interest and preference information from the various web sites or other web services and that received directly may be optionally categorized into a hierarchically arranged set of semantic information to allow the experience, interest and preference information from different web sites or other web services to be arranged into a single common framework.

Users may then be matched based on mutual experiences, preferences and interests or types thereof. The matching may be a function of any or all of the intensity of the experience, interest or preference, how rare such an experience, interest or preference is, as well as similarity of experiences, interests or preferences.

Users may manually select other users who have one or more experiences, interests or preferences, and who also have characteristics (e.g. height, weight, sex, sexual preference) identified by that user.

Users so matched or selected may then mutually participate in an activity that requires movement of the users to attend or participate in the activity or involves the use of two or more computers over a network such as an Ethernet network or the Internet.

### BRIEF DESCRIPTION OF THE DRAWINGS

FIG. 1 is a block schematic diagram of a conventional computer system.

FIG. 2 is a flowchart illustrating a method of matching users for activities using experience, interest and/or preference information from one or more independently operated web sites or other web services according to one embodiment of the present invention.

FIG. 3 is a block schematic diagram of a system for matching users for activities using experience, interest and/or preference information from one or more independently operated web sites or other web services according to one embodiment of the present invention.

### DETAILED DESCRIPTION OF A PREFERRED EMBODIMENT

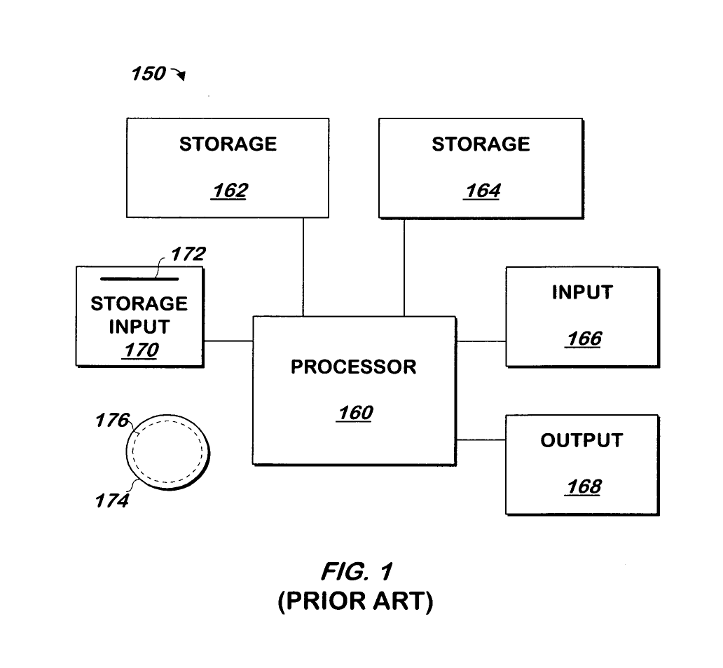

The present invention may be implemented as computer software on a conventional computer system. Referring now to FIG. 1, a conventional computer system 150 for practicing the present invention is shown. Processor 160 retrieves and executes software instructions stored in storage 162 such as memory, which may be Random Access Memory (RAM) and may control other components to perform the present invention. Storage 162 may be used to store program instructions or data or both. Storage 164, such as a computer disk drive or other nonvolatile storage, may provide storage of data or program instructions or both. In one embodiment, storage 164 provides longer term storage of instructions and data, with storage 162 providing storage for data or instructions that may only be required for a shorter time than that of storage 164. Input device 166 such as a computer keyboard or mouse or both allows user input to the system 150. Output 168, such as a display or printer, allows the system to provide information such as instructions, data or other information to the user of the system 150. Storage input device 170 such as a conventional floppy disk drive or CD-ROM drive accepts via input 172 computer program products 174 such as a conventional floppy disk or CD-ROM or other nonvolatile storage media that may be used to transport computer instructions or data to the system 150. Computer program product 174 has encoded thereon computer readable program code devices 176, such as magnetic charges in the case of a floppy disk or optical encodings in the case of a CD-ROM which are encoded as program instructions, data or both to configure the computer system 150 to operate as described below.

In one embodiment, each computer system 150 is a conventional SUN MICROSYSTEMS SPARC ENTERPRISE M9000 SERVER running the SOLARIS operating system commercially available from ORACLE CORPORATION of Redwood Shores, Calif., a PENTIUM-compatible personal computer system such as are available from DELL COMPUTER CORPORATION of Round Rock, Tex. running a version of the WINDOWS operating system (such as 95, 98, Me, XP, NT, 2000, Vista or 7) commercially available from MICROSOFT Corporation of Redmond Wash. or a Macintosh computer system running the MACOS or OPENSTEP operating system commercially available from APPLE INCORPORATED of Cupertino, Calif. and the FIREFOX browser commercially available from MOZILLA FOUNDATION of Mountain View, Calif. or INTERNET EXPLORER browser commercially available from MICROSOFT above, although other systems may be used. Each computer system 150 may be a mobile telephone system such as the DROID 2 mobile telephone commercially available from MOTOROLA CORPORATION of Schaumberg, Ill. running the ANDROID operating system commercially available from GOOGLE, INC. of Mountain View, Calif. Various computer systems may be employed, with the various computer systems communicating with one another via the Internet, a conventional cellular telephone network, an Ethernet network, or all of these.

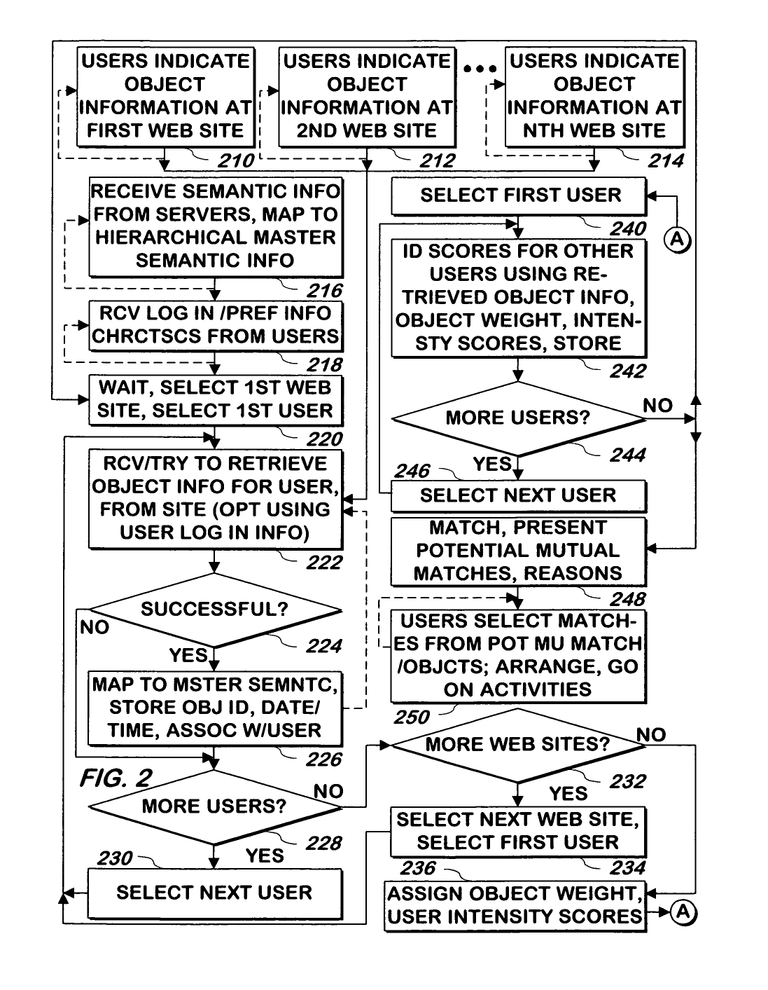

Referring now to FIG. 2, a method of matching users for activities according to experience, interest, and/or preference information gathered from one or more independently operated web sites or other web services is shown according to one embodiment of the present invention. As described herein, information may be received from web sites, but some or all of the experience, interest and preference information may be received from web services that may not be web sites. The web services may retrieve information from web sites, for example, and therefore, users may supply the information to web sites via the web services. The companies providing some or all of the web services may be independent of the company performing some or all of the matching functions described herein. Thus, a “web site” as used herein need not provide an actual web site to the public, as it may be include such web sites as well as any web service from which experience, interest or preference information may be received as described herein.

Receipt and Storage of Experience, Interest and Preference Information by the N Web Sites.

As part of an independently running process, users indicate to a first web site, and the first web site receives and stores, information regarding objects with which the user has experienced, in which the user has expressed an interest, or for which the user has expressed a preference 210.

As part of an independently running process, users indicate to a second web site, and the second web site receives and stores, information regarding objects, with which the user has experienced, in which the user has expressed an interest, or for which the user has expressed a preference 212.

As part of an independently running process, users indicate to an Nth web site and the Nth web site receives and stores, information regarding objects, with which the user has experienced, in which the user has expressed an interest, or for which the user has expressed a preference 214.

Although three web sites are described, N may be any number and any number of web sites may be used. In one embodiment, each of some or all of the web sites is independent of one another. A web site is independent of another web site if the two web sites are operated by or for businesses, with one of the businesses not controlling or under control of at least one other of the businesses. For example, the first web site may be Facebook.com and the second web site may be foursquare.com.

As described herein, the Nth web site may be a web site that performs some or all of steps 216-248 described herein. The Nth web site may be operated by or for a business that is independent of at least one of the other web sites or all of the other web sites. The N web sites operate using conventional web servers coupled to a network such as the Internet. Because different web sites may obtain different information from users, and such information may be different from that obtained by the entity that performs steps 216-236, the experience, interest and preference information used as described herein may be more complete than could be obtained by such entity alone.

Steps 210-214 operate as independently operating processes, not dependent on one another as indicated by the dashed lines in the Figure, and may operate occasionally or continuously. Users may supply experience, interest and preference information to a web site at any time, and some users may supply experience, interest and preference information to more than one of the web sites.

Objects.

In one embodiment, the objects with which a user has indicated an experience or for which a user has indicated an interest or preference include objects that are not, at the time they are so indicated, indicated by such user solely for the purpose of identifying characteristics of other users with which the user providing the indication would like to be matched for one or more activities. For example, objects may be so indicated by a user to educate friends or others who follow such indications of theirs. An object may be a location, type of music, a song, a photograph, etc.

An indication of an experience may be provided when a user uses a function to check in or provide a review on Yelp.com or another web site to which users can post reviews. An indication of an interest or preference or interest may be a provided when a user uses a like function on Facebook.com.

Receive Semantic Information, Optionally Map to Master List.

Semantic information may be optionally received or retrieved 216 from some or all of the web sites or the business entity for which the web sites are operated. In one embodiment, semantic information is a list of objects for which users of at least one web site hosted by the web site may indicate an experience, interest or preference. The list may have no organization (e.g. it may just be a flat list) or it may have a hierarchical organization, that can be represented by nodes and links, such as is used in a conventional tree structure. For example, a song by a hip hop artist may be organized on the list in the hierarchical arrangement as being in the song category, hip hop songs subcategory, hip hop songs by the artist subcategory of hip hop songs, and then the name of the song itself. Thus, the objects may be the leaf nodes on the tree of the hierarchical arrangement of objects for which an experience, preference or interest may be indicated.

In one embodiment, a master list of semantic information is prepared by the party performing some or all of the method of steps 216-248 as part of step 216. The master list is a list of objects from all web sites from which information may be retrieved, and that may be used to attempt to uniquely identify objects that are in fact the same or similar objects from different web sites, or to identify as a single object two objects from the same web site that may be described differently. For example, the master list may contain Miley Cyrus as an object, even though object experience, interest or preference information for her received from different web sites may identify her as Miley Cyrus or Hanna Montanna (a character played by Miley Cyrus).

As part of step 216, as new objects are received on the semantic information from a web site, a mapping may be added or maintained between the objects on the semantic information received or retrieved from the that web site to objects on the master list. Thus, the Miley Cyrus and Hanna Montanna objects from the semantic information from Facebook.com may be mapped to the Miley Cyrus object on the master list. Step 216 may operate as a continuously or occasionally operating process so that additional semantic information is received (and optionally added to the master list), as indicated by the dashed line in the Figure.

Receive User Information.

Various set up information is received 218 from, and/or assigned to, users of the matching web site (described below). The set up information may include, for each user:
a username and password of the user;
log on or other information for each of the web sites operated by the other web sites described above on which that user is also a user (or other information such as the username or a username and a password necessary to obtain the experience, interest or preference information the user supplied to one or more of the web sites provided by the web sites) and the name or URL of the web site;
a description of characteristics of the user (e.g. height, weight, sex, sexual preference, etc.) and one or more photos of the user;
information regarding preferences for other users with which the user would like to be matched (e.g. sex, sexual orientation, etc.).

Step 218 may operate as a continuously or occasionally operating process, so that different users may supply or update such information at any time.

In one embodiment, step 218 may include using the set up information received to arrange for automatic delivery by a web site of information regarding experiences, interests or preference of a user, for example, via an RSS feed.

Experience, Interest and Preference Information Collection.

At the end of a time period, such as one day, an experience, interest and preference information collection cycle is started 220. The experience, interest and preference information collection cycle receives or retrieves from all of the web sites described above, experience, interest and preference information for each user of the matching web site (described below) that was supplied by that user to the web sites as described above, and associates the object corresponding to the preference and interest information with the user's account at a web site operated by the party performing some or all of the method of steps 216-248. This web site is referred to herein as the “matching web site”.

To start this collection cycle, a first web site is selected from those described above and a first user of the matching web site is selected 220. The user selected may be one for which information (such as log on information) for that web site was received by the user as described above. An attempt is made to retrieve object experience, interest or preference information for the selected user from the selected web site, optionally using the user information for that web site provided by the user as described above 222. Step 222 may include eliminating duplicate information previously received for that user from that web site (e.g. using a date and time the experience, interest or preference was recorded, for example). If the attempt is successful 224, each object for which the user indicated a preference or interest from the web site is optionally mapped to the master semantic information, and either an identifier of the object or an identifier of an object corresponding to the mapped master semantic information is stored, optionally with the date and time the experience, interest or preference was indicated to the web site or the current time, associated with the user selected as described above 226, and the method continues at step 228. If the attempt is unsuccessful 224, method continues at step 228.

If there are more users 228, the next user is selected 230, and the method continues at step 222 using the newly selected user. If there are no more users 228, if there are more web sites 232, the next web site is selected, the first user is selected as described above 234, and the method continues at step 222 using the newly selected web site and the newly selected user.

Some of the web sites (or other web sites, for example, those which scrape information from such web sites) may allow for object experience, interest or preference information to be provided by the web site, and such provision is arranged at step 218 as described above optionally using the set up information. In such embodiment, steps 222-226 include receiving such information as it becomes available, identifying the user to which it corresponds and the web site from which it was received (e.g. using the set up information and information received with such information) and then if the identification is successful, performing step 226 using the identified user identifier and list of the web site. These steps may be performed as or after the information is received, in a continuous fashion, as indicated by the dashed line in the Figure.

In one embodiment, if an object experience, interest or preference not on the master list is retrieved, it is added to the master list and mapped as described above as part of step 222.

Compute Object Weights and User Intensity Scores.

If there are no more web sites 232, statistics based on the object experiences, interests and preferences retrieved are computed 236.

One statistic computed as part of step 236 is an object weight. An object weight may be computed for each of the objects either on the master semantic list, or on an other list of some or all objects associated with the users in step 226 to indicate how rarely an experience, interest or preference for that object has been indicated across some or all users. Thus, an object for which a preference or interest has been indicated by a few users will receive a higher object weight than an object for which an interest or preference has been indicated by many users.

In one embodiment, the object weight is computed and stored for each day (or a different period, along with an indication of the period), and only takes into account how many users indicated an interest in, or preference for the object during that day and a number (e.g. 60) or zero or another number of preceding days. Other periods of computation may be used: for example, after 60 days, the daily object weight may be averaged for a calendar month and stored, and then the daily object weights are deleted.

The use of object weights stored by day or other period allows objects that were once popular (and therefore had a lower object weight) to later receive a higher object weight at a time they may no longer be as popular, or vice versa. The object weight used as described herein is the object weight that applies to the date the experience, interest or preference was indicated or retrieved.

In still another embodiment, a single object weight is computed for each object, with the single object weight affected by more recent experience, interest or preference indications for that object more heavily than less recent experience, interest or preference indications. Thus, the weight for an object can fluctuate, though it may do so in a somewhat smoothed manner.

In one embodiment, another statistic computed as part of step 236 is a set of user/object/category intensity scores for some or all objects for which an experience, interest or preference was indicated by each user. The score pertains to a single object or category, and a single user. A user/object/category intensity score (referred to as an “intensity score”) is a score that indicates a degree of experience, interest or preference by one user for an object, or, if a master set of semantic information is used, and it is arranged hierarchically, the user/object/category intensity score may also be computed for categories, subcategories and the like for each user to indicate the number of experiences, interests or preferences the user has with objects in the category. The user/object/category intensity score may be assigned on a 0-10 scale, and may be computed relative to other users' experience, interest or preference information for the same object or category/subcategory. For example, if the user indicated on Facebook.com that the user liked several songs of a particular genre more than the average user who liked at least one song in that genre, the user/object/category intensity score for the user for the subcategory that corresponded to the genre would be assigned a value greater than 5 if a 0-10 scale was used.

Score Users.

The users may be scored using the information retrieved and identified as described above, as will now be described.

To score users, a first user is selected 240 from among users of the matching web site. A set of other users of the matching web site that have characteristics that match a threshold (which may be 100) percentage of the selected user's desired characteristics for other users as described above and for which the selected user has characteristics that match a threshold percentage of the other user's desired characteristics of other users, are identified (i.e. they are cross-matched), and a score is assigned to each such other user. The score may be a function of:
how many, and the weights of, objects the selected user and the other user have in common from among those stored associated with those users as described above; and/or
how many objects and/or categories or subcategories for which the selected user and the other user have above average intensity scores in common.

Scoring of another user for the selected user (both of which are referred to as the “pair of users”) may be performed using any of a variety of methods. One such method will now be described. The object weights for each object for which the pair of users has expressed an experience, interest or preference, may be summed. In the embodiment in which object weights are stored for different periods, one half the object weight in effect at the time the user indicated the preference or interest is summed for each user. In another embodiment, the object weight in effect at the time the selected user indicated the experience, interest or preference is used as the object weight. In one embodiment, if multiple experiences, interests and preferences are expressed, the highest object weight in effect at the time is used, or an average may be used.

The intensity score for the object may be used to increase the score, for example, if the intensity score of an object for which the pair of users expressed an experience, interest or preference is higher than a threshold value for both users of the pair of users, the object weight for that object may be multiplied by the average intensity score of the pair of users for that object and the product may be added to the sum instead of the object weight.

In the embodiment in which a master hierarchically arranged list of objects is used to store the preferences or interests of the users, a contribution to the score may be made when the two users being scored have experiences, interests or preferences that fall within the same category or subcategory. The score contribution for the pair of users having object experiences, interests or preferences in the same category or subcategory may be greater the closer the category in common is to a leaf node. For example, the sum of the product of the intensity scores for the objects for which either of the two users being scored have indicated an interest that are in the same category or sub category divided by: twenty multiplied by ten to the power of the number of hierarchical levels from the leaf node to that category or subcategory, may be added to the score for the pair of users as described above if both such users have intensity scores in the category or subcategory that are above average for that category or subcategory.

The use of intensity scores for preferences or interests that are in the same category or subcategory can allow users who have relatively intense, similar but not the same, interests to be matched: for example, those that like hip hop music will have a higher score even if they don't have an experience, interest or preference in the exact same songs.

If there are more users 244, the next such user (or user not marked as above) is selected 246 and the method continues at step 242 using the newly selected user.

Match Users.

If there are no more users 244, the method continues at step 220, and additionally the users are matched 248 using the scores computed as described above. Matching of users may be one way, in which case, the one or more other users that have the highest score for each user selected as described above are identified as that user's potential mutual match. Matching of users may be two way, in which case the users who have the highest sum of scores with respect to one another (e.g. the score for the user computed when the other user was selected in step 240 or 246 and the score for the other user when the user was selected in step 240 or 246) may be assigned as potential mutual matches.

In one embodiment, the cross matching of desired characteristics of other users described above is performed among all users before users are selected in steps 240 and 246 as described herein, and users who have the smallest number of such cross matches are matched before other users who have a higher number of such cross matches.

The activities for which users are matched need not be specified at the time the users are matched as described herein, or users may be matched for a specific activity.

The identifiers of users assigned as potential mutual matches are stored associated with the user for which they were matched or with one another as part of step 242.

The potential mutual matches are presented to the users as part of step 248. For example, when a user logs in, the potential mutual match or matches assigned to that person may be displayed to the user. The reasons that the other user was (or users were) selected as a potential mutual match may be displayed as part of step 248. Reasons may include the names of the objects for which the users had expressed an experience, interest or preference in common. For example, when a user logs in, characteristics of the other user may be displayed, along with the name of the objects that were matched with the other user, with an indication of the object score (for example, by displaying the names of the objects using different colors according to the object score e.g. red for the object score being in a highest range of object scores, blue for a middle range and green for a lower range). The names of categories and subcategories that had a contribution to the score that exceeds a threshold may also be displayed.

The users for whom a potential mutual match was made may arrange to perform activities together, and perform such activities, such as participating in a telephone call, chat or email exchange (using at least one server), arranging an activity to which the users travel, such as a date or an event, or any other activity 250. In one embodiment, the users indicate whether they are interested in one another, and when both users so indicate an interest, their usernames (or other information) are revealed to one another, and until then, their usernames or other information are not revealed to one another. In another embodiment, the other user's identity is displayed as part of step 248 and either user may initiate the activity to perform with the other, which the other is free to accept or refuse. When the users perform an activity together, the two users become a “proximate pair” which means a pair of users in proximity with one another: before that time, the two users are a “non proximate pair”, which means users who are not in proximity with one another.

In one embodiment, at any time, users may browse names of objects (e.g. those on the master list), either hierarchically using the same or similar organization as the master list, or by requesting and receiving a display of the objects or categories or subcategories corresponding to their own experiences, interests, and preferences. The user may select an object, category or subcategory, and see other users who expressed a preference or interest in the object or in any object in the category or subcategory selected who also have the characteristics, or a threshold percentage of the characteristics, of other users desired by that user. For example, the objects, categories or subcategories on the master list or associated with the user may be displayed to the user as links and when the user clicks the link, the profile information of the corresponding other users who have indicated the experience, interest or preference and who also have the characteristics for other users, or a threshold percentage of the characteristics for other users, desired by that user, are presented to the user if the other user has a threshold (e.g. 100) percentage of characteristics matching those desired by the user as part of step 250, the requesting user may then send a message to the other user initiating an activity and the users then may then perform an activity as described above.

System.

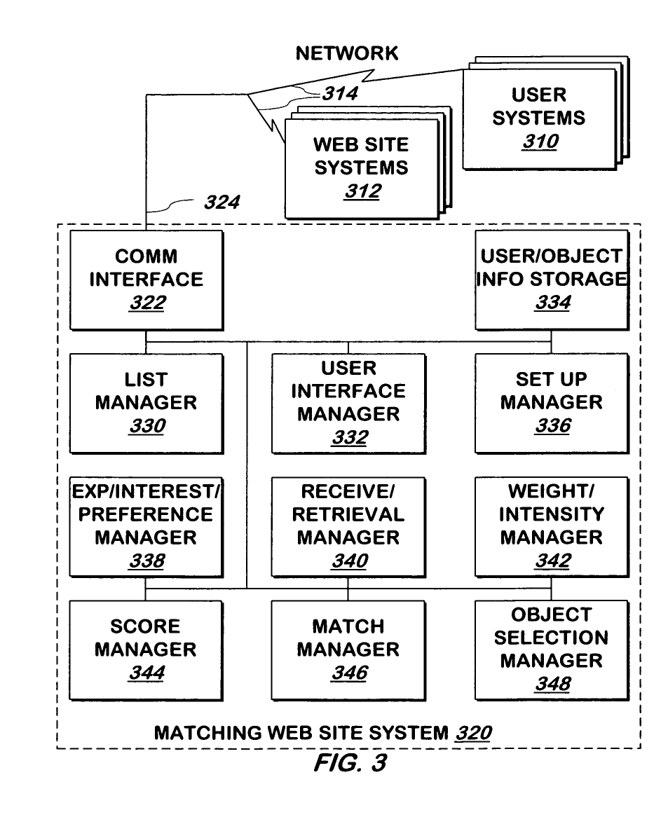

Referring now to FIG. 3, a system for matching users for activities according to experience, interest, and/or preference information gathered from one or more independently operated web sites is shown according to one embodiment of the present invention. The system of FIG. 3 includes multiple user systems 310 and multiple web site systems 312 operating the web sites 1 through n−1 as described above, each coupled to a network 314, such as an Ethernet network, the Internet, or both. User systems 310 are composed of conventional personal computer systems or cellular telephones running a conventional browser and are used by users to perform all communication (except telephone calls) described herein. Web site systems 312 may each be made of one or more servers running conventional web server software, and may include software operating review and/or social networking functions that allow users to indicate one or more experiences, interests or preferences for one or more objects as described herein.

Users of web site systems 312 use their browsers on their user systems 310 to each indicate to one or more experiences, interests or preferences with or for one or more objects as described above. Web site systems 312 provide conventional user interfaces to allow the receipt of such information and store such information associated with a user identifier of the respective web site receiving such information and optionally, the date of receipt.

Also coupled to the network via input/output 324 is communication interface 322 of matching web site system 320 that operates as described above and herein. Web site system 320 performs web server functions in addition to the functions described herein. Communication interface 322 includes a conventional communication interface running suitable communication protocols such as TCP/IP, Ethernet and other communication protocols. All communication between matching web site system 320 and web site systems 312 and between matching web site system 320 and user systems 310 is made via communication interface 322.

Matching web site system 320 may be completely machine implemented. The various modules 322-348 described herein that make up matching web site system 320 may be made up at least in part of electronic circuitry.

Periodically, or occasionally, list manager 330 may receive for each of the web sites the name or URL of the web site and the list of objects for which users can or have expressed an experience for, an interest in, or a preference for, on the web sites corresponding to web site systems 312 either from a system administrator or from the web sites themselves and may store such lists into user/object information storage 334, which may include conventional memory or disk storage. List manager 330 may use the list of one web site as a starting point for the master list by copying it into user/object information storage 334 and creating a one to one mapping between that web site's list and the master list.

When a list from another such web site is received, list manager 330 attempts to match the names of objects from the newly received list to the objects on the master list and then maps the objects on the list to the master list. Objects not mapped may be manually mapped by a system administrator or added to the list.

As new lists are received, list manager 330 compares the new list to the old to identify newly added objects, adds the new object to the list for that web site and either adds the new objects to the master list if they do not match an existing entry (and optionally if a system administrator cannot manually map them to one) and maps the object from the web site list to the master list or maps them from the web site list to the master list if they match an existing entry on the master list.

User interface manager 332 receives conventional web server requests from user systems 310 and provides web based user interfaces that allows operation as described herein. A user may use a user interface provided by user interface manager 332 to supply the user's username and password in order to log in, or to create them, which user interface manager 332 stores in user/object information storage 334. Once logged in, the user may use a link provided by user interface manager 332 to receive a user interface provided by set up manager 336, which allows the user to provide the set up information described above with reference to step 218 described above. Set up manager 336 receives and stores such set up information into user/object information storage 334, associated with a user identifier for the user. Conventional cookies or link referrer information may be used to transfer the user identifier from user interface manager 332 to other components as described herein.

If one of the web sites or a different web service provides delivery of experience, interest and/or preference information supplied to one or more of the web sites corresponding to web site systems 312, set up manager 336 uses the set up information received to arrange such delivery by the web site or by a different service.

Experience/interest/preference manager 338 allows users of matching web site system 320 to indicate experience with, interest in, or preference for any object on the master list as described herein. In one embodiment, user interface manager 332 displays profile information regarding the various users in the manner of a conventional online dating web site using the profile information stored in user/object information storage 334. As it renders the page, it provides text on the page (and indicates the start of new lines) to experience/interest preference manager 338, which uses the words on the page and conventional regular expression techniques to match object names on the list with words being rendered. If a word about to be supplied to a user system 310 is found to match an object on the list, experience/interest preference manager 338 generates a link to itself containing an identifier of the object and provides it to user interface manager 332 to display next to the word or words corresponding to the object name, along with an indication as to the appropriate location on the page. User interface manager 332 provides such link or links on the pages it provides. If a user reviewing the page clicks the link to indicate an interest or preference, the identifier of the object is provided to experience/interest preference manager 338, which retrieves the user's user identifier from the cookie and stores into user/object information storage 334, associated with the user identifier retrieved, an indication of an interest or preference by that user for the object corresponding to the identifier.

In one embodiment, a user may download to a mobile phone an application for the mobile phone that reports the user identifier of a user who has logged into the application and location of the user (via a GPS signal) when the user so requests. Map coordinates indicating one or more locations of objects may be stored associated with some of the objects (e.g. corresponding to places), either by receiving them with the object names from the web sites or by looking them up in a conventional map database. There may be multiple locations corresponding to some objects, such as the name of an object representing a chain store or restaurant that does not otherwise contain an indication of a location (in which case a smaller number of locations, such as one location, would be stored associated with the object name). Experience/interest preference manager 338 receives the user identifier and location from the mobile phone application, translates the location into an object name, and stores into user/object information storage 334 an indication of the experience with the object associated with the user identifier.

Periodically or occasionally, receive/retrieval manager 340 automatically receives experience, interest, and preference information (and an indication of the web site from which it was received and the user to which it corresponds). Additionally, receive/retrieval manager 340 periodically or occasionally, performs the experience, interest and preference information collection cycle described above using a list of web sites and URLs provided by a system administrator and stored in user/object information storage 334, and the set up information stored in user/object storage 334 provided by the users, to retrieve for each user and web site from which it is available as described above, experience, interest and preference information for the users of the matching web site system 320 from web site systems 312 as described above.

In each case above, an object name is received or retrieved by receive/retrieval manager 340. Receive/retrieval manager 340 obtains the identifier of the corresponding object on the master list, using the mapping of objects from that web site to the master list stored in user/object information storage as described above, or by matching the name of the object received from the web site with an object master list (and adding it if it is not in the list) and stores into user/object information storage 334 such experience, interest and preference information associated with the user identifier to which it corresponds (i.e. the user identifier corresponding to the set up information used to retrieve such experience, interest and preference information or the user identifier of the matching web site corresponding to the user identifier received with such information) and an identifier of the web site to which the user provided such information that it identified when it retrieved the information or was received with it (or could be derived from information received with it, such as the source IP address or other similar information).

When receive/retrieval manager 340 has completed retrieving and storing the experience, interest and preference information as described above or after a sufficient amount of such information has been received (which may be a single experience, interest or preference), receive/retrieval manager 340 signals weight/intensity manager 342.

When so signaled, weight/intensity manager 342 computes the weight for each object using the experience, interest and preference information stored in user/object information storage 334 as described above, and for each object on the master list, stores the object weight of that object associated with the object identifier on the master list into user/object information storage 334, optionally with the current date.

Weight/intensity manager 342 optionally computes the intensity of each object for each user as described above using the experience, interest and preference information and the master list stored in user/object information storage 334, and for each user and object, stores the intensity for each object associated with the user identifier and object to which the intensity corresponds. After it has completed computing the weights or weights and intensities, weight/intensity manager 342 signals score manager 344.

When so signaled, score manager 344 selects users, identifies other users for (using desired characteristics supplied by the selected user, characteristics of the other users, characteristics of the selected user and desired characteristics of the other users, all of which are stored in user/object information storage 334), and computes the scores for users as described above and stores the user identifier of each other user and the score for each other user associated with the user identifier of the user selected as described above, and the current date, using the experience, interest and preference information, the object weights, and optionally, the intensity information stored in user/object information storage 334 as described above. When all of the scores have been computed and stored by score manager 344, score manager 344 signals match manager 346.

When so signaled, match manager 346 identifies potential mutual matches for each of the users for which a match is available using the scores for the current date stored as described above, and stores in user/object information storage 334 the user identifiers of the potential mutual matches, reasoning information for the selection of each match as described above, and the current date, associated with the user identifier for which the match corresponds.

When a user logs in, user interface manager 332 displays the user's potential mutual matches as described above, and optionally receives an interest indication from each of the pairs of users matched and if both interest indications are positive, provides the user identifiers of each of the pair of users matched to one another. Users may use a conventional messaging capability provided by user interface manager 332 to arrange an activity and then move themselves (e.g. by dialing a phone, or meeting) or use multiple computers coupled to a network to perform the activity. When the users meet, they change from a non-proximate pair to a proximate pair. Arranging the activity facilitates the transformation of the users from a non-proximate pair to a proximate pair.

A user may click a link provided by user interface manager 332 to view the master list of experiences, interests or preferences or to view the experiences, interests or preferences, of themselves or another user. When clicked, the link provides the name of the object to object selection manager 348. When it receives the name of the object, object selection manager 348 retrieves the username of the user who clicked the link via a cookie or referred information added to the link and looks up in user/object information storage 334 the preference information for other users provided (as set up information) by the user who clicked the link and identifies other users whose characteristics match or otherwise correspond to a threshold amount of such preference for other user information. Object selection manager 348 uses the object name and preference information stored in user/object information storage 334 to identify other users of matching web site system 320 who match or otherwise correspond to the preference information it retrieves and who have indicated an experience, interest or preference for the object corresponding to the clicked link, either directly to the matching web site system 320 or to the web site systems 312 retrieved as described above, and provides the usernames of such other users to user interface manager 332, which displays information from such user's profile. A user may click a link provided by user interface manager 332 to view his or her own profile or may use conventional search functions provided by user interface manager to view the profiles of one or more users. Included with the profile information for a user that is displayed by user interface manager 332 are object names for objects that the user has experienced, or expressed an interest in or preference for, along with the aforementioned links. Category and subcategory information for other users may also be displayed with their profiles, or such information may be displayed only for those categories for which the intensity score is above a threshold.

### SUMMARY

There has been described a method of at least facilitating the moving of a first person and a second person who are not in physical proximity with one another into physical proximity with one another, the method including receiving for each of a plurality of people, including the first person and the second person, at a first computer system from at least one second computer system coupled to the first computer system via a network, a mixture of experience, interest, and preference information of the plurality of people provided to the second computer system by the respective person in the plurality, each person providing at least one selected from experience, interest and preference information, associating the experience, interest and preference information with the user that had the experience, interest or preference, for each of at least some pairs of the plurality of people, computing at least one score responsive to a similarity of the experience, interest and preference information received from said pair, for each of at least some of the plurality of people, identifying to the first person at least one other of the plurality of people comprising the second person responsive to the at least one score computed with respect to at least one of said two people, and at least facilitating said moving the first person and the second person into said proximity, so as to cause a transformation of said persons from a non proximate pair into a proximate pair.

The method may be such that at least one of the at least one score is computed responsive to identifying a rarity of an experience, interest, or preference.

The method may be such that the rarity is identified as a function of time.

The method may be such that the score is identified responsive to an intensity of interest in at least one experience, interest or preference by at least one of the persons in the pair.

The method may be such that at least one of the at least one second computer system comprises computer system to which at least one of the plurality of people has provided a review of a product or service.

The method may be such that the identifying step is responsive to the first person being optimal for the second person as indicated by at least one score, but the second person need not be optimal for the first person, as indicated by a different at least one score.

The method may be such that the identifying step is responsive to an optimization of both persons towards one another, as indicated by a plurality of the scores.

The method may be such that the at least one second computer system includes two or more second computer systems, and may additionally include mapping the experience, interest and preference information received from the plurality of second computer systems to at least one master list of experience, interest and preference objects, at least some of the objects on each of the at least one master list being mapped from the experience, interest or preference information received from at least two of the plurality of second computer systems; and the computing the score step may be additionally responsive to the mapping step.

A computer program product comprising a computer useable medium having computer readable program code embodied therein, the computer program product comprising computer readable program code devices configured to cause a computer system to perform the functions of the method, is also described.

A system for at least facilitating the moving of a first person and a second person who are not in physical proximity with one another into physical proximity with one another, is described. The system includes a receive/retrieval manager having an input coupled to a network for receiving, for each of a plurality of people, including the first person and the second person, experience, interest, and preference information of the plurality of people provided to the second computer system by the respective person in the plurality, each person providing at least one selected from experience, interest and preference information, the receive/retrieval manager for associating the experience, interest and preference information with an identifier of the person to which such information corresponds, and for providing such information and person identifier at an output, a score manager having an input coupled to the receive/retrieval manager output for receiving the information and user identifiers, the score manager for, for each of at least some pairs of the plurality of people, computing at least one score responsive to a similarity of the experience, interest and preference information received from said pair and for providing at an output the at least one score for each of at least some of the pairs, and identifiers of the persons in the pair to which each such score corresponds, and a match manager having an input coupled to the score manager output for receiving the at least one score of at least some of the pairs, and the identifiers of the pair, the score manager for, for each of at least some of the plurality of people, identifying to the first person, via an output, at least one other of the plurality of people comprising the second person responsive to the at least one score computed with respect to at least one of said two people.

The system may additionally include a weight/intensity manager having an input coupled to the receive/retrieval manager output for receiving the information, the weight/intensity manager for identifying a weight responsive to a rarity of each of a plurality of the experiences, interests, or preferences of the information received at the weight/intensity manager input and for providing at an output an identifier of at least some of the experiences, interests and preferences and the weight identified for the respective experience, interest or preference, the score manager input may be additionally coupled to the weight/intensity manager for receiving the identifiers and the weights, and the score manager may compute at least one of the at least one score additionally responsive to a weight of an experience, interest, or preference corresponding to at least one of the pair.

The system may include the feature that the receive/retrieval manager stores the experience, interest and preference information associated with at least one selected from a date and a time;

the weight/intensity manager identifies the weight of an experience, interest and/or preference additionally responsive to at least one selected from the date and time associated with that experience, interest and/or preference.

The system may additionally include a weight/intensity manager having an input coupled to the receive/retrieval manager output for receiving the information and the person identifier, the weight/intensity manager for identifying, for each of at least some of the plurality of people, and for each of at least some of the experiences, interests and/or preferences of the respective person, an intensity score indicating an intensity of said experience, interest or preference by that person, responsive to the information and identifiers received at the weight/intensity manager input and for each of at least some of the intensities identified, providing at an output an identifier of the person, an identifier of the experience, interest, or preference of the intensity identified, and an indicator of the intensity of the experiences, interests and preferences, for said person, and the score manager input may be additionally coupled to the eight/intensity manager for receiving the identifiers of the persons, the identifiers of the experience, interest, or preference of the intensity identified, and an indicator of the respective intensities of the experiences, interests and preferences, for said person; and the score manager may compute at least one of the at least one score responsive to at least one indicator of at least one intensity corresponding to at least one of the pair.

The system may include the feature that at least one of the at least one second computer system comprises computer system to which at least one of the plurality of people has provided a review of a product or service.

The system may include the feature that the match manager identifies responsive to the first person being optimal for the second person as indicated by at least one score, but the second person need not be optimal for the first person, as indicated by a different at least one score.

The system may include the feature that the match manager identifies responsive to an optimization of both persons towards one another, as indicated by a plurality of the scores.

The system may additionally include a user interface manager having an input/output for receiving and providing information for at least facilitating said moving the first person and the second person into said proximity, so as to cause a transformation of said persons from a non proximate pair into a proximate pair.

What is claimed is:

1. A method of at least facilitating the moving of a first person and a second person who are not in physical proximity with one another into physical proximity with one another, the method comprising:
receiving for each of a plurality of people, including the first person and the second person, at a first computer system from at least one second computer system coupled to the first computer system via a network, a mixture of experience, interest, and preference information of the plurality of people provided to the second computer system by the respective person in the plurality, each person providing at least one selected from experience, interest and preference information;
associating the experience, interest and preference information with the user that had the experience, interest or preference;
for each of at least some pairs of the plurality of people, computing at least one score responsive to a similarity of the experience, interest and preference information received from said pair;
for each of at least some of the plurality of people, identifying to the first person at least one other of the plurality of people comprising the second person responsive to the at least one score computed with respect to at least one of said two people; and
at least facilitating said moving the first person and the second person into said proximity, so as to cause a transformation of said persons from a non proximate pair into a proximate pair.

2. The method of claim 1, wherein at least one of the at least one score is computed responsive to identifying a rarity of an experience, interest, or preference.

3. The method of claim 2, wherein the rarity is identified as a function of time.

4. The method of claim 1, wherein the score is identified responsive to an intensity of interest in at least one experience, interest or preference by at least one of the persons in the pair.

5. The method of claim 1, wherein at least one of the at least one second computer system comprises computer system to which at least one of the plurality of people has provided a review of a product or service.

6. The method of claim 1, wherein the identifying step is responsive to the first person being optimal for the second person as indicated by at least one score, but the second person need not be optimal for the first person, as indicated by a different at least one score.

7. The method of claim 1, wherein the identifying step is responsive to an optimization of both persons towards one another, as indicated by a plurality of the scores.

8. The method of claim 1:
wherein the at least one second computer system comprises a plurality of second computer systems;
additionally comprising mapping the experience, interest and preference information received from the plurality of second computer systems to at least one master list of experience, interest and preference objects, at least some of the objects on each of the at least one master list being mapped from the experience, interest or preference information received from at least two of the plurality of second computer systems; and
the computing the score step is additionally responsive to the mapping step.

9. A system for at least facilitating the moving of a first person and a second person who are not in physical proximity with one another into physical proximity with one another, the system comprising:
a receive/retrieval manager having an input coupled to a network for receiving, for each of a plurality of people, including the first person and the second person, experience, interest, and preference information of the plurality of people provided to the second computer system by the respective person in the plurality, each person providing at least one selected from experience, interest and preference information, the receive/retrieval manager for associating the experience, interest and preference information with an identifier of the person to which such information corresponds, and for providing such information and person identifier at an output;
a score manager having an input coupled to the receive/retrieval manager output for receiving the information and user identifiers, the score manager for, for each of at least some pairs of the plurality of people, computing at least one score responsive to a similarity of the experience, interest and preference information received from said pair and for providing at an output the at least one score for each of at least some of the pairs, and identifiers of the persons in the pair to which each such score corresponds; and
a match manager having an input coupled to the score manager output for receiving the at least one score of at least some of the pairs, and the identifiers of the pair, the score manager for, for each of at least some of the plurality of people, identifying to the first person, via an output, at least one other of the plurality of people comprising the second person responsive to the at least one score computed with respect to at least one of said two people.

10. The system of claim 9:
additionally comprising a weight/intensity manager having an input coupled to the receive/retrieval manager output for receiving the information, the weight/intensity manager for identifying a weight responsive to a rarity of each of a plurality of the experiences, interests, or preferences of the information received at the weight/intensity manager input and for providing at an output an identifier of at least some of the experiences, interests and preferences and the weight identified for the respective experience, interest or preference; and
wherein the score manager input is additionally coupled to the weight/intensity manager for receiving the identifiers and the weights; and
the score manager computes at least one of the at least one score additionally responsive to a weight of an experience, interest, or preference corresponding to at least one of the pair.

11. The system of claim 10, wherein:
the receive/retrieval manager stores the experience, interest and preference information associated with at least one selected from a date and a time;
the weight/intensity manager identifies the weight of an experience, interest and/or preference additionally responsive to at least one selected from the date and time associated with that experience, interest and/or preference.

12. The system of claim 9:
additionally comprising a weight/intensity manager having an input coupled to the receive/retrieval manager output for receiving the information and the person identifier, the weight/intensity manager for identifying, for each of at least some of the plurality of people, and for each of at least some of the experiences, interests and/or preferences of the respective person, an intensity score indicating an intensity of said experience, interest or preference by that person, responsive to the information and identifiers received at the weight/intensity manager input and for each of at least some of the intensities identified, providing at an output an identifier of the person, an identifier of the experience, interest, or preference of the intensity identified, and an indicator of the intensity of the experiences, interests and preferences, for said person; and
wherein the score manager input is additionally coupled to the weight/intensity manager for receiving the identifiers of the persons, the identifiers of the experience, interest, or preference of the intensity identified, and an indicator of the respective intensities of the experiences, interests and preferences, for said person; and
the score manager computes at least one of the at least one score responsive to at least one indicator of at least one intensity corresponding to at least one of the pair.

13. The system of claim 9, wherein at least one of the at least one second computer system comprises computer system to which at least one of the plurality of people has provided a review of a product or service.

14. The system of claim 9, wherein the match manager identifies responsive to the first person being optimal for the second person as indicated by at least one score, but the second person need not be optimal for the first person, as indicated by a different at least one score.

15. The system of claim 9, wherein the match manager identifies responsive to an optimization of both persons towards one another, as indicated by a plurality of the scores.

16. The system of claim 9, additionally comprising a user interface manager having an input/output for receiving and providing information for at least facilitating said moving the first person and the second person into said proximity, so as to cause a transformation of said persons from a non proximate pair into a proximate pair.

17. The method of claim 9, wherein:
the at least one second computer system comprises a plurality of second computer systems;
the receive/retrieval manager input is additionally coupled for receiving a master list of experience, interest and preference objects;
the receive/retrieval manager is additionally for mapping the experience, interest and preference information received from the plurality of second computer systems to at least one object on the master list of experience, interest and preference objects, at least some of the objects on each of the at least one master list being mapped by receive/retrieval manager from the experience, interest or preference information received from at least two of the plurality of second computer systems, and providing said mappings at the receive/retrieval output,
the score manager input is additionally for receiving the mappings; and
the score manager computes the scores additionally responsive to the mappings received at the score manager input.

18. A computer program product comprising a computer useable medium having computer readable program code embodied therein for at least facilitating the moving of a first person and a second person who are not in physical proximity with one another into physical proximity with one another, the computer program product comprising computer readable program code devices configured to cause a computer system to:
receive for each of a plurality of people, including the first person and the second person, at a first computer system from at least one second computer system coupled to the first computer system via a network, a mixture of experience, interest, and preference information of the plurality of people provided to the second computer system by the respective person in the plurality, each person providing at least one selected from experience, interest and preference information;
associate the experience, interest and preference information with the user that had the experience, interest or preference;
for each of at least some pairs of the plurality of people, compute at least one score responsive to a similarity of the experience, interest and preference information received from said pair;
for each of at least some of the plurality of people, identify to the first person at least one other of the plurality of people comprising the second person responsive to the at least one score computed with respect to at least one of said two people; and
at least facilitate said moving the first person and the second person into said proximity, so as to cause a transformation of said persons from a non proximate pair into a proximate pair.

19. The computer program product of claim 18, wherein at least one of the at least one score is computed responsive to identifying a rarity of an experience, interest, or preference.

20. The computer program product of claim 19, wherein the rarity is identified as a function of time.

21. The computer program product of claim 18, wherein the score is identified responsive to an intensity of interest in at least one experience, interest or preference by at least one of the persons in the pair.

22. The computer program product of claim 18, wherein at least one of the at least one second computer system comprises computer system to which at least one of the plurality of people has provided a review of a product or service.

23. The computer program product of claim 18, wherein the computer readable program code devices configured to cause the computer system to identify are responsive to the first person being optimal for the second person as indicated by at least one score, but the second person need not be optimal for the first person, as indicated by a different at least one score.

24. The computer program product of claim 18, wherein the computer readable program code devices configured to cause the computer system to identify are responsive to an optimization of both persons towards one another, as indicated by a plurality of the scores

25. The computer program product of claim 18:
wherein the at least one second computer system comprises a plurality of second computer systems;
additionally comprising computer readable program code devices configured to cause the computer system to map the experience, interest and preference information received from the plurality of second computer systems to at least one object on a master list of experience, interest and preference objects, at least some of the objects on each of the at least one master list being mapped from the experience, interest or preference information received from at least two of the plurality of second computer systems; and
the computer readable program code devices configured to cause the computer system to compute the scores are additionally responsive to the computer readable program code devices configured to cause the computer system to map.
